(19) United States
(12) Patent Application Publication
(10) Pub. No.: US 2016/0103075 A1
(43) Pub. Date: Apr. 14, 2016

(54) WIRELESS REMOTE OPTICAL MONITORING SYSTEM

(71) Applicant: Detekt Biomedical LLC., Austin, TX (US)

(72) Inventors: Damon Vincent Borich, Austin, TX (US); Alejandro Silveyra, Austin, TX (US); Andrea Grbavac, Austin, TX (US); Karen Borich, Austin, TX (US)

(21) Appl. No.: 14/878,445

(22) Filed: Oct. 8, 2015

Related U.S. Application Data
(60) Provisional application No. 62/062,234, filed on Oct. 10, 2014.

(51) Int. Cl. G01N 21/78; H04W 84/18

(52) U.S. Cl. CPC G01N 21/78; H04W 84/18

(57) ABSTRACT

An optical analysis system is disclosed. The optical analysis system includes a wireless optical device. The wireless optical device includes a body with a port that receives a test strip. A sensor array may be positioned within the body that aligns with at least part of the test strip. The sensor array may include a plurality of individually addressable sensors and at least one illumination element associated with each sensor. The at least one illumination element may illuminate a discrete portion of the test strip that is aligned with the individually addressable sensor associated with the at least one illumination element. The sensors may independently assess reflected illumination signals from the discrete portions of the test strip aligned with the individually addressable sensors.

### PRIORITY CLAIM

This patent claims priority to U.S. Provisional Patent Application No. 62/062,234 to Borich et al., entitled “REMOTE MONITORING SYSTEM”, filed Oct. 10, 2014, which is incorporated by reference in its entirety.

### BACKGROUND

1. Technical Field

Embodiments described herein relate to systems and methods for diagnostic testing. More particularly, embodiments described herein relate to a wireless universal diagnostic and monitoring system for solid, liquid, gas, environmental samples, rapid test strips, dry chemistry strips, and micro-fluidic biochips for chemical and bio-chemical assays utilizing a wireless optical device for quantitative data reporting.

2. Description of Related Art

Significant advances have been made in the arena of optical detection technology and in particular in the use of CMOS sensors for analytical image capture and processing. Recent diagnostic and monitoring product developments are utilizing onboard sensors embedded in consumer products such as smartphones, tablets, and other imaging accessories. While these products and associated methods reduce the need for additional imaging and sensor hardware, the ability to control the sensor and the imaging environment is often suboptimal. For example, utilizing existing camera phone sensors may require the use of corrective lenses and filters to achieve a proper imaging quality. External illumination may also be needed to provide a consistent imaging environment as ambient and/or onboard flash lighting (e.g., built-in flash) can be variable in wavelength and intensity and is not an ideal source of light. Additionally, as consumer products frequently cycle through new product developments, standardization of the optical environment for consumer products may be difficult and cumbersome when accommodating multiple devices with different image sensors, optics, and/or illumination characteristics.

Thus, there is a need for a modular universal sensing and imaging system which can be coupled to a variety of existing wireless industrial and/or consumer computing devices. Such modular universal sensing and imaging system may utilize an existing device's inherent display, user interface, operating system, and/or connectivity options while maintaining a standard calibrated electro-optical input device for consistent data acquisition across multiple platforms and devices.

### SUMMARY

In certain embodiments, an optical analysis system includes a body with a port configured to receive at least one test strip. A sensor array may be positioned within the body. The sensor array may be positioned to align with at least part of the at least one test strip when the at least one test strip is received in the port. The sensor array may include a plurality of individually addressable sensors and at least one illumination element associated with each sensor. The at least one illumination element may illuminate a discrete portion of the at least part of the at least one test strip. The discrete portion may be aligned with the individually addressable sensor associated with the at least one illumination element. The individually addressable sensors may be configured to independently assess reflected illumination signals from the discrete portions of the at least part of the at least one test strip aligned with the individually addressable sensors.

In certain embodiments, a method includes illuminating a test strip located in an optical analyzer body with a plurality of illumination elements located in the optical analyzer body. Illumination from the test strip may be received in a plurality of sensors located in the optical analyzer body. Each sensor may be associated with at least one illumination element. Using a computer processor, a signal intensity of the illumination may be independently assessed on each of the sensors receiving illumination from the test strip. Using the computer processor, the assessed signal intensities may be interpolated between the sensors receiving illumination from the test strip. Using the computer processor, a sensor with a selected assessed signal intensity in comparison to the assessed signal intensities of its neighboring sensors may be selected. Using the computer processor, a set of sensors in proper position above a test region on the test strip may be determined based on the interpolation of the assessed signal intensities and the selected sensor with the selected assessed signal intensity.

In some embodiments, the test strip includes a test strip with a test region having a known illumination pattern for a specific type of assay. The method may further include determining the set of sensors in proper position above the test region in the known illumination pattern and generating a template for optical analysis of test strips with the specific type of assay. The generated template may include using the determined set of sensors to assess illumination from such test strips. In some embodiments, a non-transient computer-readable medium includes instructions that, when executed by one or more processors, causes the one or more processors to perform the method described above.

### BRIEF DESCRIPTION OF THE DRAWINGS

Features and advantages of the methods and apparatus of the embodiments described in this disclosure will be more fully appreciated by reference to the following detailed description of presently preferred but nonetheless illustrative embodiments in accordance with the embodiments described in this disclosure when taken in conjunction with the accompanying drawings in which:

FIG. 1 depicts a representation of an embodiment of a wireless optical analysis system.

FIG. 2 depicts an exploded view of an embodiment of a wireless optical device showing body parts and internals of the wireless optical device.

FIG. 3 depicts a representation of an embodiment of a body part with a test strip holder inserted in a port.

FIG. 3A depicts a representation of an embodiment of a test strip holder with three magnets.

FIG. 4 depicts an enlarged top view of an embodiment of a sensor board.

FIG. 5 depicts an enlarged bottom view of an embodiment of a sensor board.

FIG. 6 depicts an enlarged bottom view of an embodiment of a sensor board with optical shields on sensor units in a sensor array.

FIG. 7 depicts a view of an optical shield from the test strip side of the optical shield.

FIG. 8 depicts a view of an optical shield from the sensor board side of the optical shield.

FIG. 9 depicts a representation of an embodiment of a test strip holder.

FIG. 10 depicts a representation of an embodiment of a test strip holder with three distinct layers.

FIG. 11 depicts a representation of light from a sensor array on a sensor board being directed to a light port on a test strip holder.

FIG. 12 depicts an alternative embodiment of a test strip holder.

FIG. 13 depicts a representation of an embodiment of a calibration test strip holder.

FIG. 14 depicts a block diagram representation of an embodiment of a sensor array with 21 sensor units.

FIG. 15 depicts a flowchart of an embodiment of a process for assessing which sensor units are positioned above the reactive region of the test strip.

FIG. 16 depicts examples of different interpolation methods that may be used to interpolate the independently assessed signal intensities.

FIG. 17 depicts a block diagram representation of an embodiment of a sensor array with a known illumination pattern illuminated on the sensor array.

FIG. 18 depicts a block diagram of one embodiment of an exemplary computer system.

FIG. 19 depicts a block diagram of one embodiment of a computer accessible storage medium.

FIGS. 20, 21, 22, 23, 24, 25, 26, 27, and 28 depict examples of screenshots that may be shown on a display of a control device.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits and/or memory storing program instructions executable to implement the operation. The memory can include volatile memory such as static or dynamic random access memory and/or nonvolatile memory such as optical or magnetic disk storage, flash memory, programmable read-only memories, etc. The hardware circuits may include any combination of combinatorial logic circuitry, clocked storage devices such as flops, registers, latches, etc., finite state machines, memory such as static random access memory or embedded dynamic random access memory, custom designed circuitry, programmable logic arrays, etc. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112(f) interpretation for that unit/circuit/component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF EMBODIMENTS

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

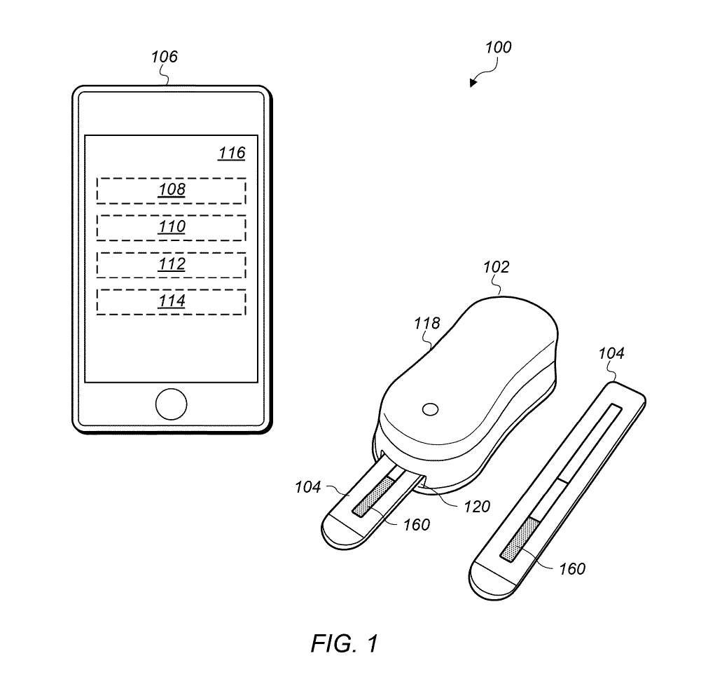

FIG. 1 depicts a representation of an embodiment of a wireless optical analysis system. In certain embodiments, optical analysis system 100 includes wireless optical device 102 and one or more test strip holders 104. In certain embodiments, optical analysis system 100 wirelessly communicates with control device 106. Control device 106 may be used to wirelessly control and operate optical analysis system 100.

In certain embodiments, control device 106 is a mobile device. For example, control device 106 may be any small computing device, typically small enough to be handheld (and hence also commonly known as a handheld computer or simply handheld). Control device 106 may include, but is not limited to, portable phones, tablets, handheld electronic devices, digital watches, wearable computing devices, and other wireless device modules. In certain embodiments, control device 106 includes any portable device with computer processor 108, wireless transceiver 110, software package 112, memory cache 114, and display 116. In some embodiments, control device 106 is a computer system such as a laptop computer or a desktop computer.

Wireless optical device 102 may be a wireless monitoring or assessment system that is portable, can be handheld, and is easy to operate. In some embodiments, wireless optical device 102 is programmed to autonomously run a preprogrammed routine. In some embodiments, wireless optical device 102 is wirelessly controlled using control device 106.

Wireless optical device 102 may be used to optically, electrically, and/or magnetically inspect and passively monitor (assess) samples (e.g., test strips 160) placed in test strip holder 104. The samples may be, for example, biologic or non-biologic samples that are solid, fluid, or gaseous in nature. Samples may include environmental samples, rapid test strips, dry chemistry strips, and micro-fluidic biochips for chemical and bio-chemical assays. Samples (e.g., test strips 160) that are assessed using wireless optical device 102 include, but are not limited to, test strips commonly used for medical, veterinary, agricultural, and/or food/beverage testing fields. Samples involved with remote monitoring of manufacturing equipment, environmental conditions, and other industrial application may also be assessed using wireless optical device 102. For example, wireless optical device 102 may be used to monitor the vibration and temperature of a piece of equipment by utilizing both optical and digital motion and temperature sensors.

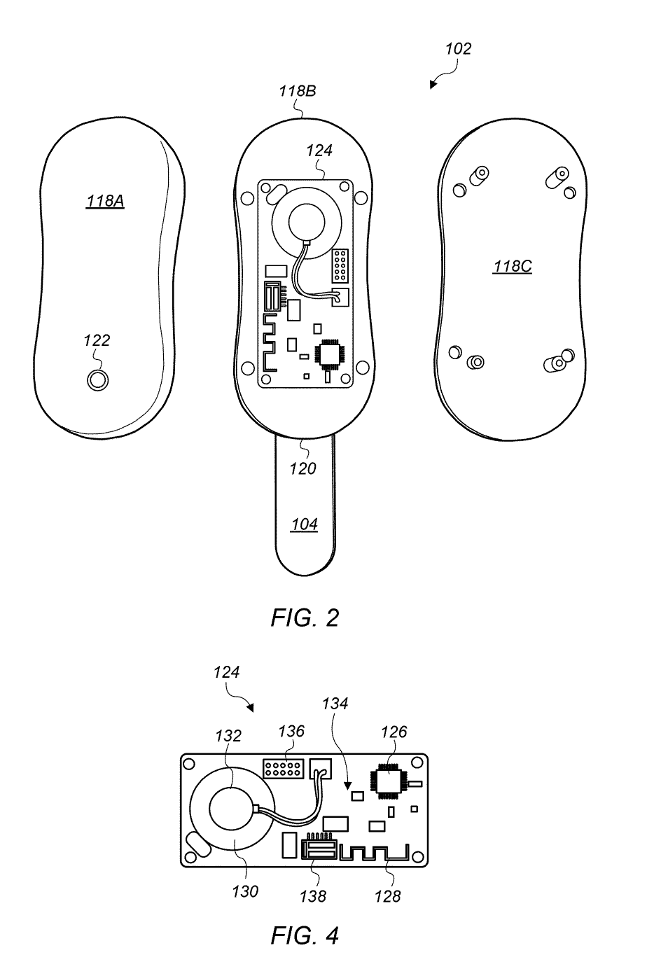

In certain embodiments, as shown in FIG. 1, wireless optical device 102 includes body 118 and port 120 in the body. Body 118 may be a multi-part housing for one or more components of wireless optical device 102. FIG. 2 depicts an exploded view of an embodiment of wireless optical device 102 showing body parts and internals of the wireless optical device. In certain embodiments, wireless optical device 102 includes top body part 118A, middle body part 118B, and bottom body part 118C. Body parts 118A, 118B, and 118C may be coupled together to form body 118 (shown in FIG. 1). In some embodiments, body part 118A includes external LED indicator 122. LED indicator 122 may include one or more programmable LEDs controlled by a sensor board (e.g., sensor board 124 described herein) to provide feedback to a user of wireless optical device 102. For example, LED indicator 122 may provide different color outputs depending on a state of wireless optical device 102.

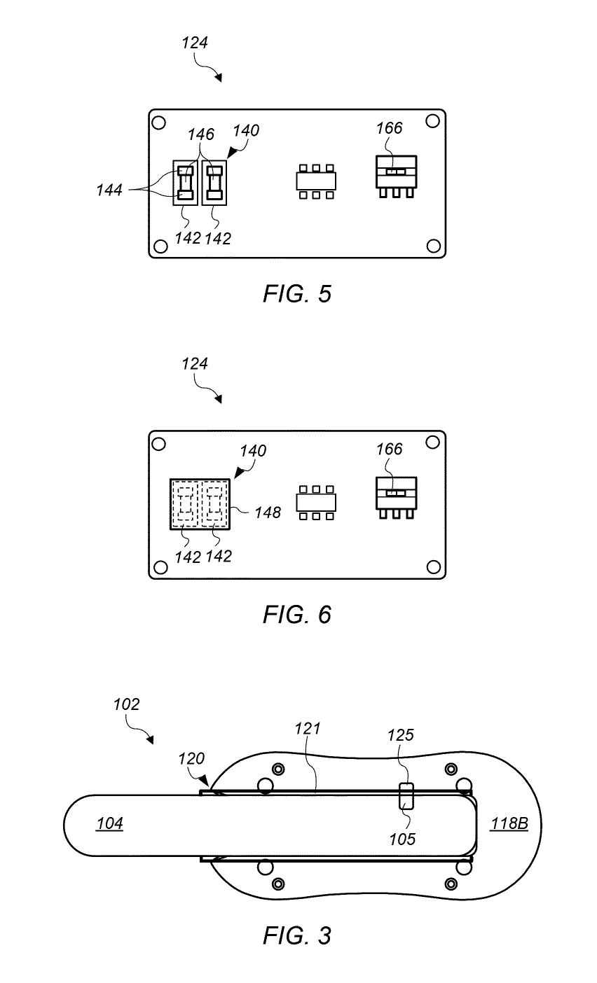

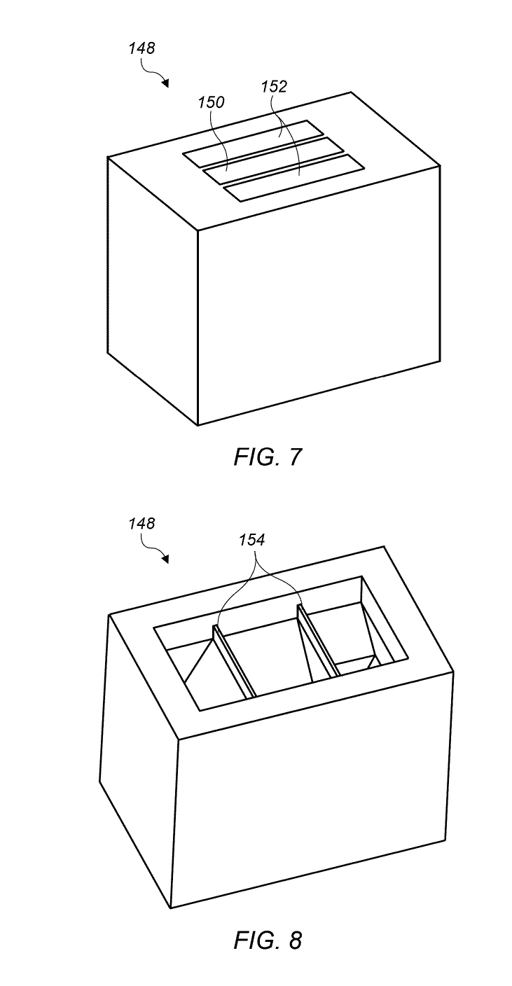

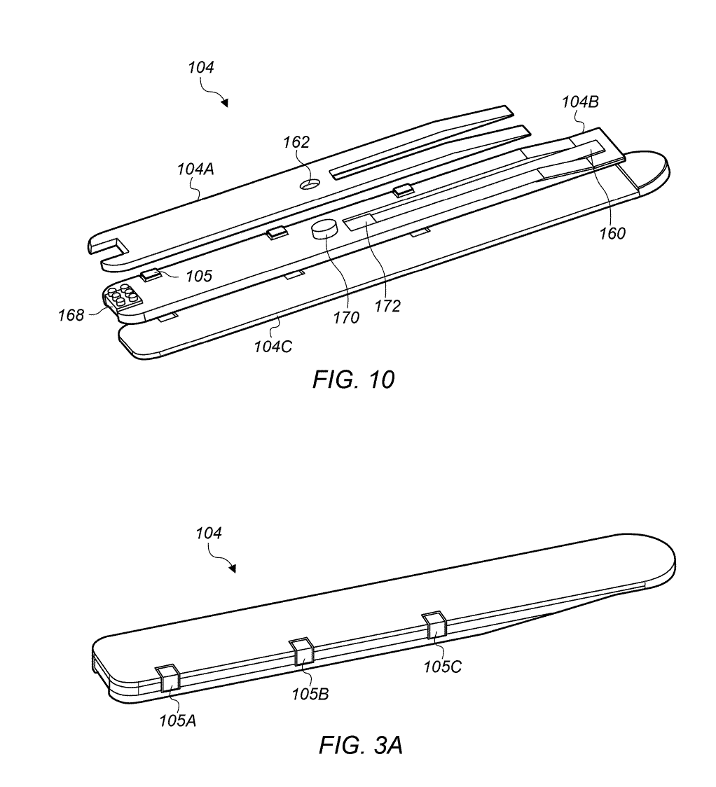

Port 120 may be located on middle body part 118B. In some embodiments, port 120 is configured to accept one or more port adapters. FIG. 3 depicts a representation of an embodiment of body part 118B with test strip holder 104 inserted in port 120. Port adapter 121 may be inserted in port 120. Port adapter 121 may allow test strip holder 104 to have different form factors (e.g., different shapes) and still be inserted into port 120. In some embodiments, port adapter 121 is coupled to port 120 using magnetic attachment devices. The magnetic attachment devices may attract, center, and hold port adapter 121 in place on port 120. Port adapter 121 may then be removed from port 120 using a pulling force that overcomes the magnetic attraction. In some embodiments, port adapter 121 is coupled to port 120 using interlocking posts and/or fasteners.

In some embodiments, port adapter 121 includes one or more magnets 125. Magnets 125 may be used to attract or repel specific regions of test strip holder 104. Test strip holder 104 may include one or more magnets 105. As shown in FIG. 3, test strip holder 104 includes magnet 105 that is attracted to magnet 125 on port adapter 121. The attraction between magnet 105 and magnet 125 automatically aligns test strip holder 104 at a predetermined position in port adapter 121 for specific testing of the test strip holder with wireless optical device 102.

In some embodiments, port adapter 121 and/or test strip holder 104 include multiple magnets placed at different locations along their lengths. For example, FIG. 3A depicts a representation of an embodiment of test strip holder 104 with three magnets 105A, 105B, 105C. Magnets 105A, 105B, 105C are located at different positions along the length of test strip holder 104. Using multiple magnets allows test strip holder 104 to be automatically aligned at different predetermined positions inside port adapter 121 and wireless optical device 102. The different alignment positions may be used to analyze different analytes of interest on a single test strip inside test strip holder 104. Thus, sequential analysis may be performed on a single test strip inside test strip holder 104 using the multiple, predetermined alignment positions. For example, urine test strips may have multiple target regions that may be analyzed by wireless optical device 102.

In some embodiments, port adapter 121, as shown in FIG. 3, is designed specific to a user's application. For example, port adapter 121 may be designed for a specific application by a user and the port adapter may be fabricated (e.g., 3D printed) according to the user's design. Such user design may allow the user to quickly design and receive a port adapter suitable for the specific application based on the user's particular test strip holder and/or testing requirements.

In certain embodiments, body 118, as shown in FIG. 1, is designed to be placed on a surface or mounted on a surface. For example, body 118 may be mounted remotely on a piece of equipment, a ceiling, a wall, or embedded in a structure. The shape and design of body 118 may be varied based on a desired use of wireless optical device 102. For example, body 118 may be designed to custom fit existing structures and/or environments.

In some embodiments, body part 118C (the lower part of body 118) is removed to allow non-conforming samples to be analyzed by wireless optical device 102. Removing body part 118C may allow a sensor array of wireless optical device 102 (described below) to be placed near a sample that cannot be placed in a test strip holder and inserted through port 120. For example, the optical sensor array may be used to assess skin tone, temperature, perfusion, and/or motion and vibration of humans and/or non-human animals.

In certain embodiments, sensor board 124 is located on middle body part 118B, as shown in FIG. 2. FIG. 4 depicts an enlarged top view of an embodiment of sensor board 124. In certain embodiments, sensor board 124 includes wireless transceiver 126, antenna 128, battery 130, and vibration motor 132. Battery 130 may be a rechargeable battery or a replaceable battery. In some embodiments, battery 130 is recharged using a power source located on test strip holder 104. Vibration motor 132 may be, for example, an integrated shaftless vibration motor. Sensor board 124 may control vibration motor 132. Vibration motor 132 may be used to provide user feedback (e.g., vibrate wireless optical device 102 when test strip holder 104 is inserted correctly) and/or provide vibrational forces to the test strip holder for certain analytical tests (e.g., vibrate the test strip holder to promote a desired reaction on the test strip such as mixing a solution, promoting fluid flow, or reacting an inserted sample).

In certain embodiments, sensor board 124 includes circuitry 134 (detail of the circuitry is not shown for simplicity in the drawing) that controls and directs operation of the sensor board and wireless optical device 102. Circuitry 134 may include, for example, a microprocessor, memory, and/or associated logic components.

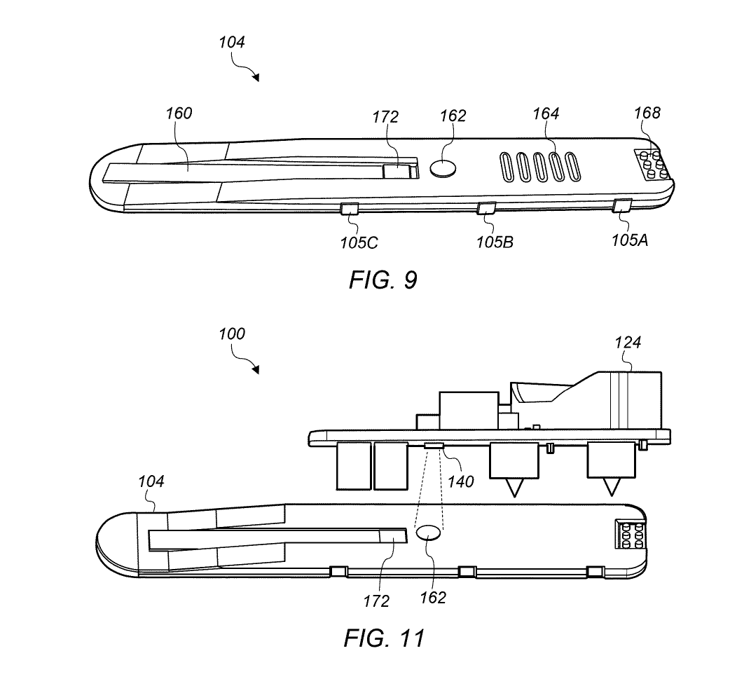

In some embodiments, sensor board 124 includes firmware connection pins 136 and/or general purpose I/O (GPIO) pins 138. GPIO pins 138 may be used for expansion of wireless optical device 102. For example, additional sensor boards or modules may be coupled to sensor board 124 through GPIO pins 138. In some embodiments, GPIO pins 138 are designed to make electrical contact with pins or contacts on test strip holder 104 (e.g., contacts 168, shown in FIG. 9). Electrical contact may be achieved for example using spring loaded pins for GPIO pins 138 or on the electrical contact on test strip holder 104. Electrical contact between sensor board 124 and test strip holder 104 through GPIO pins 138 may allow the sensor board to send and/or receive signals and/or data from discrete components and/or sensors in the test strip holder. Thus, GPIO pins 138 provide expansion capability through test strip holder 104 having enhancements such as embedded sensors or electronics.

In certain embodiments, wireless transceiver 126 is a wireless transceiver capable of self-broadcasting its unique configuration. Wireless transceiver 126 may operate using standard frequency protocols such as WiFi, Bluetooth, RFID, or other standard or available technologies and/or frequencies. Wireless transceiver 126 may be programmed to automatically connect to a control device (e.g., a mobile device) in proximity to wireless optical device 102. The automatically connected control device may be running (actively or in the background) an approved application that is compatible with wireless optical device 102 that is stored in the software package of the control device (e.g., software package 112 in control device 106, shown in FIG. 1). Automatic connection of wireless optical device 102 to the control device may allow a user to discover and locate wireless optical devices located in previously unknown or undeclared areas.

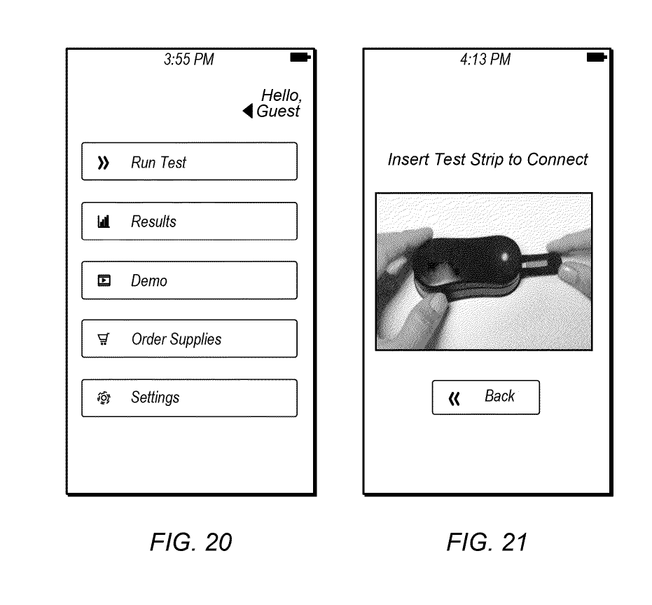

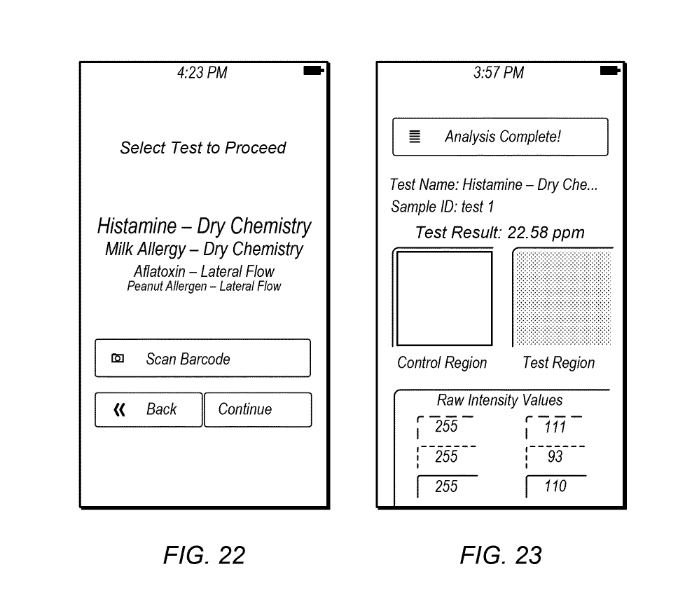

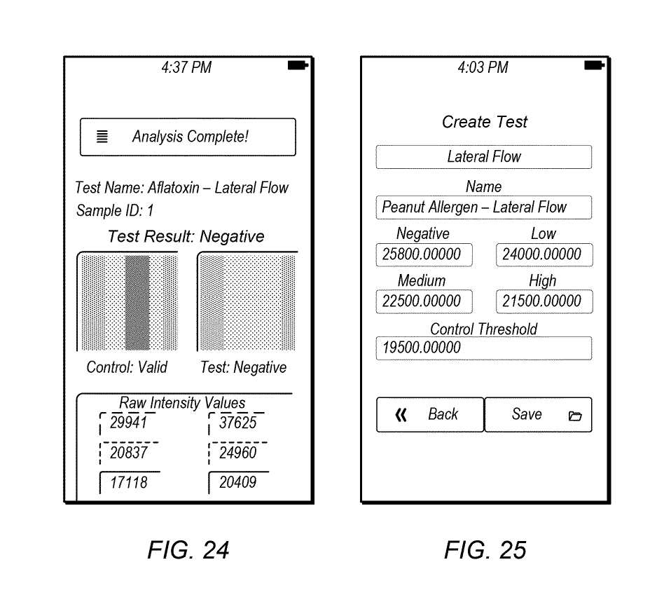

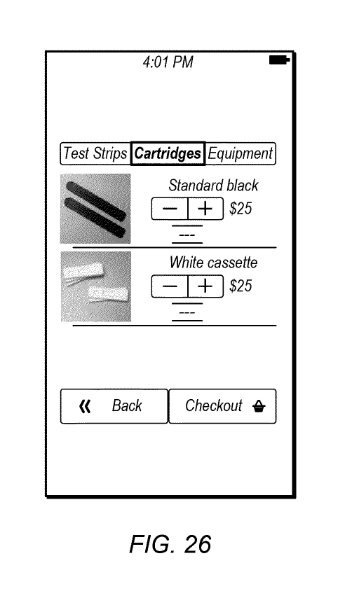

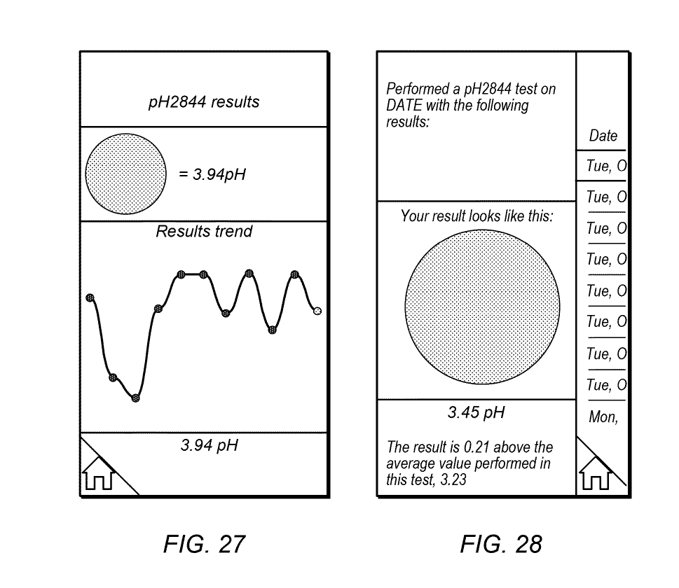

FIGS. 20-28 depict examples of screenshots that may be shown on display 116 of control device 106. The screenshots depict example embodiments of potential layouts and user interfaces that may be used with control device 106 to operate and interface with wireless optical device 102. The screenshots provide examples of user selectable control interfaces (FIGS. 20 and 22) for a test routine, image viewing including, for example, visual instructions (FIG. 21), results viewing (FIGS. 23, 24, 27, and 28), form fillable pages (FIG. 25), wireless connectivity, and additional features such as an online store for purchasing test strip holders (FIG. 26). FIGS. 27 and 28 further depict examples of results tracking (such as data trend and/or comparison) available for multiple tests using a test strip type (e.g., pH test strip). These screenshots are merely provided as examples and one skilled in the art would recognize that the layouts and interfaces may be altered or varied as desired.

FIG. 5 depicts an enlarged bottom view of an embodiment of sensor board 124. In certain embodiments, sensor board 124 includes sensor array 140. Sensor array 140 may include a plurality of sensor units 142. The embodiment shown in FIG. 5 depicts two sensor units 142 in sensor array 140 for simplicity in the drawing. It should be noted, however, that sensor array 140 may include any number of sensor units 142 needed or desired for a particular embodiment wireless optical device 102. For example, the number of sensor units 142 may be determined by the number of different applications desired for wireless optical device 102.

In certain embodiments, sensor unit 142 includes one or more illumination elements 144 and at least one sensor 146. Illumination elements 144 may be, for example, LED illumination elements. In some embodiments, illumination elements 144 are optically tuned, programmable illumination elements. Sensor 146 may be, for example, a CMOS sensor and/or a photodiode. Illumination elements 144 may illuminate a surface of a test strip inside wireless optical device 102 (e.g., a target surface). Light reflected from the surface of the test strip is returned to sensor 146. In certain embodiments, sensor 146 assesses color signals (e.g., colorimetric signal) from the test strip. In certain embodiments, sensor 146 assesses an RGB number intensity (e.g., a raw RGB signal intensity) of color signals from the test strip.

In certain embodiments, illumination elements 144 and/or sensor 146 are focused to provide and receive light from a discrete portion of the surface of the test strip. In some embodiments, illumination elements 144 and/or sensor 146 are focused using lens components. In certain embodiments, illumination elements 144 and/or sensor 146 are focused using an interchangeable optical shield. FIG. 6 depicts an enlarged bottom view of an embodiment of sensor board 124 with optical shields 148 on sensor units 142 in sensor array 140. Optical shields 148 may focus light towards and/or from a discrete portion of the surface of the test strip.

FIGS. 7 and 8 depict a representation of an embodiment of optical shield 148. FIG. 7 depicts a view of optical shield 148 from the test strip side of the optical shield. FIG. 8 depicts a view of optical shield 148 from the sensor board side of the optical shield. In certain embodiments, optical shield 148 includes sensor window 150 and light exit areas 152, as shown in FIG. 7. Sensor window 150 may be used to focus or direct light (illumination) towards sensor 146 while light exit areas 152 focus or direct light (illumination) from illumination elements 144 to the surface of the test strip. In certain embodiments, light exit areas 152 focus light onto the discrete portion of the surface of the test strip (e.g., light is only provided to the discrete portion or area of interest on the surface) and sensor window 150 directs light to be only received from the discrete portion of the test strip. Thus, optical shield 148 inhibits illumination to/from portions of the test strip other than the discrete portion. Optical shield 148 may include optical barriers 154, shown in FIG. 8. Optical barriers 154 may separate the illumination region from the sensing region at the sensor board.

In certain embodiments, optical shield 148 (and/or a lensing component coupled to sensor 146 and/or illumination elements 144) allows sensor 146 to detect various shapes and objects on the test strip based on their optical signature in either the colorimetric or non-colorimetric color spectrums. For example, optical shield 148 may include an internally reflective cavity (e.g., the walls of optical barriers 154 may be reflective). The internally reflective cavity may act as a light pipe that provides high efficiency transmission of light from the surface of the test strip to sensor 146.

In some embodiments, optical shield 148 includes optical filters. The optical filters may be used to include or exclude selected ranges of wavelengths and/or intensities of light in each sensor unit 142. The optical filters may be electronically controlled using sensor board 124. In some embodiments, the optical filters are varied for different detection modes (e.g., the optical filters are varied based on a desired application for wireless optical sensor 102).

In some embodiments, sensor board 124, shown in FIGS. 3-6, includes additional modular sensors. The modular sensors may be used to monitor or assess other properties such as, but not limited to, temperature, humidity, pressure, rotational and acceleration forces (e.g., using digitally coupled gyroscopes and accelerometers), vibration forces, and magnetic forces (e.g., using a magnetometer). The additional modular sensors may be added to sensor board 124 using a universal I2C connectivity port or another standard chip level communication protocol. In some embodiments, monitoring of the additional modular sensors is used to trigger actions in sensor array 140. For example, sensor array 140 may be triggered to take an optical reading using one or more sensor units 142 when the temperature and humidity reach selected set points or values.

FIG. 9 depicts a representation of an embodiment of test strip holder 104. Test strip holder 104 may be a cartridge type device (e.g., a sampling cartridge device). Test strip holder 104, as described above, is configured to be provided into wireless optical device 102 using port 120 and/or port adapter 121, as shown in FIG. 3. As shown in FIG. 9, test strip holder 104 may include a port or insertion region for inserting test strip 160. Test strip 160 may include, but not be limited to, a lateral flow test strip, a reactive chemistry pad, a fluid sample, and a fluid vesicle.

In certain embodiments, test strip holder 104, with test strip 160 inserted in the holder, is exposed (either actively or passively) to a liquid, solid, gaseous, or other ambient environmental condition as part of a testing or monitoring procedure. Test strip holder 104 may be exposed to the testing environment either prior to or after insertion of the holder into wireless optical device 102.

In certain embodiments, test strip holder 104 includes light port 162. Light port 162 may be an internal light transmission port (e.g., the port transmits light to the internals of the holder) or a light pipe. Light port 162 allows light directed from sensor array 140, shown in FIGS. FIGS. 5 and 6, to be delivered to specific areas of test strip holder 104 using one or more optically transmissive light ports inside the holder. The light ports may be formed using fiber optic strands, internally reflective plastics, or other coated transparent light propagating or reflecting materials. Using the lights ports, light from sensor array 140 may be redirected in all axes to supply light at specific angles to the surface of test strip 160 irrespective of the orientation of the test strip surface to the sensor array.

In some embodiments, test strip holder 104 includes marks 164. Marks 164 may be visible or non-visible optical calibration marks or standards that are individually or simultaneously inspected by sensor board 124 in order to verify the identity of test strip holder 104. For example, marks 164 may indicate a selected test to be run by sensor board 124 for a specific test strip holder. In some embodiments, marks 164 are used to verify the insertion position and/or orientation of test strip holder in wireless optical device 102. Marks 164 may also be used to adjust for optical drift or noise in both sensors 146 and/or illumination elements 144.

In some embodiments, as described herein, test strip holder 104 includes magnets 105 (e.g., magnets 105A, 105B, 105C). Magnets 105 may be placed at known locations (e.g., at known intervals and/or with known patterns) along the length of test strip holder 104. Magnets 105 may be used to align test strip holder in port 120 on wireless optical device 102. In some embodiments, magnets 105 may signal a user (e.g., via a feedback force of the magnets against magnets in wireless optical device 102) specific inspection points in the wireless optical device as test strip holder 104 is advanced into port 120.

In some embodiments, as shown in FIGS. 5 and 6, sensor board 124 includes switch 166. Switch 166 may be a magnetically or mechanically triggered switch or sensor that activates sensor board 124 when test strip holder is inserted into port 120. Switch 166 may be, for example, a Reed switch. In some embodiments, switch 166 interacts with magnets 105 on test strip holder 104, shown in FIG. 9, to assess a position, orientation, motion, or velocity of the test strip holder.

In certain embodiments, test strip holder 104 includes two or more distinct layers. FIG. 10 depicts a representation of an embodiment of test strip holder 104 with three distinct layers—top layer 104A, middle layer 104B, and bottom layer 104C. In certain embodiments, light pipe 170 is integrated in middle layer 104B. Top layer 104A and bottom layer 104C may include optical barriers that inhibit stray light from reaching middle layer 104B. The optical barriers may also keep light from light pipe 170 contained in test strip holder 104. Middle layer 104B may be made from a material that transmits light efficiently from a region around light pipe 170. In some embodiments, middle layer 104B includes features that direct light received through light port 162 (e.g., light from sensor array 140) to sample portions of test strip holder 104 (e.g., portions with test strip 160). For example, light may directed to reactive region 172 on test strip 160. FIG. 11 depicts a representation of light from sensor array 140 on sensor board 124 being directed to light port 162 on test strip holder 104 and the light being redirected to reactive region 172.

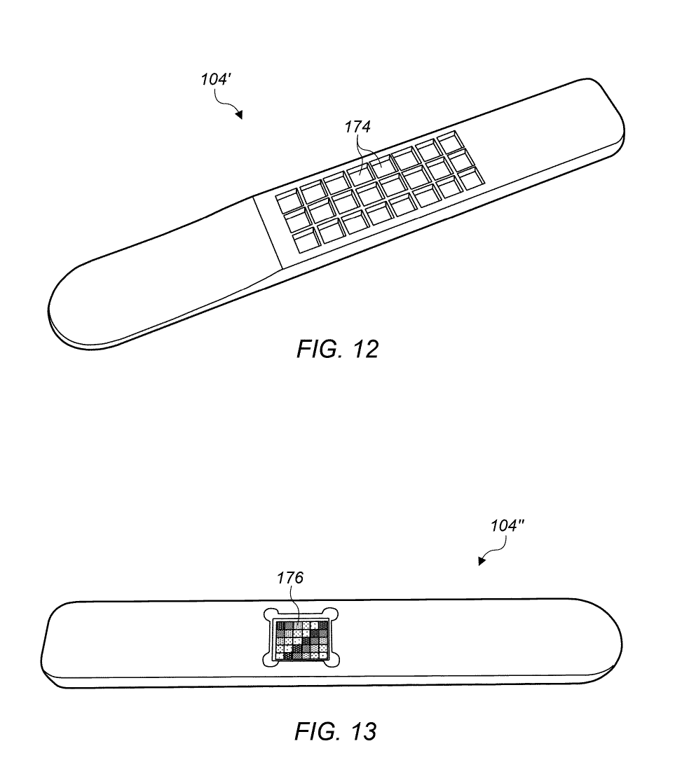

FIG. 12 depicts an alternative embodiment of a test strip holder. Test strip holder 104′ may include integrated (or embedded) test strip regions on the test strip holder. Thus, test strip holder 104′ may not require the use of test strips. Test strip holder 104′ may include extruded plastic resin filaments such as ABS, PLA, or other blends. The plastic resin filaments may be printed (e.g., 3D printed). In certain embodiments, the printable plastic is embedded with reactive dyes and chemistry such that the plastic resin is used to both make the structural components of test strip holder 104′ and provide a reactive response (e.g., colorimetric response) when exposed to an analyte being tested, for example, when the test strip holder is dipped into a fluid sample.

As shown in FIG. 12, test strip holder 104′ may include multiple testing wells 174. In some embodiments, each well 174 has a different reactive (colorimetric) response associated with the well. A variety of colorimetric analyte sensitive dyes may be pre-mixed, embedded, or encased in the structural components of test strip holder 104′ during the fabrication (e.g., printing) process. The variety of dyes may be used to provide individual testing wells 174. The dyes may be used to provide a quantitative color change indicating various sample properties such as, but not limited to, pH, nitrate concentration, peroxide concentration, iron concentration, lead concentration, or other analyte concentration.

FIG. 13 depicts a representation of an embodiment of a calibration test strip holder. Test strip holder 104″ may include calibration standard 176. Calibration standard 176 may be a color calibration standard. Calibration standard 176 may have known color properties (e.g., intensities, contrasts, etc.) that are used to calibrate wireless optical sensor 102.

In certain embodiments, wireless optical sensor 102 is controlled wirelessly using control device 106, shown in FIG. 1. For example, control device 106 may include program instructions in a computer readable storage medium (e.g., software package 112) that communicates wirelessly with wireless optical sensor 102 via sensor board 124. Software package 112 may be capable of updating the firmware of wireless optical sensor 102 in addition to providing control operations for the wireless optical sensor.

In some embodiments, data collected by control device 106 from wireless optical sensor 102 is uploaded (e.g., uploaded in real-time) to a remote network storage facility or a cloud based network using the connectivity options on the control device. In some embodiments, data collected by control device 106 is stored in memory cache 114 of the control device. Data stored in memory cache 114 may be uploaded later to a host device or other storage system for local storage on the host device.

In some embodiments, data collection results from wireless optical sensor 102 are geotagged using location capabilities on control device 106. For example, data collection results may be geotagged with GPS or WiFi coordinate locations accessed by control device 106. In some embodiments, an internal test database and subsequent results look-up tables may be adjusted automatically based on a specific geolocation of control device 106 and wireless optical sensor 102 (e.g., the geolocation where the data was collected). Such adjustment may compensate for varying regional thresholds for detection of specific analytes or attributes.

In some embodiments, multiple control devices access the same wireless optical sensor. Thus, multiple control devices and/or users may use a single wireless optical sensor as needed. In some embodiments, multiple wireless optical sensors communicate with each other and transmit configuration and/or testing protocols to each other. Such communication may provide a spatially oriented diagnostic and monitoring mesh network.

In certain embodiments, data collected from wireless optical device 102 by control device 106 is run through one or more processing algorithms. The processing algorithms may be located (stored) in software package 112 on control device 106. For example, a processing algorithm may include delineating regions of signal from areas of noise or background based upon the intensity of the signal in each color channel for a selected assay type and sample type. In some embodiments, a processing algorithm includes a calibration routine used to calibrate wireless optical device 102 for different assay types. For example, test strip holder 104″, shown in FIG. 13, may be used for the calibration routine. In some embodiments, the calibration routine defines a lower raw intensity value (e.g., raw color intensity value) for a negative sample, and a higher raw intensity value for a positive sample, or vice versa.

In certain embodiments, sensors 146, shown in FIGS. 5 and 6, are individually addressable sensors (e.g., the sensors are discrete sensors that can be operated independent of each other). Individually addressable sensors 146 may be located in individual sensor units 142. Thus, illumination elements 144 in each sensor unit 142 may be associated with and specific to the individually addressable sensor 146 located in the sensor unit.

Each sensor unit 142 focuses light towards and receives focused light from a discrete portion on the surface of the test strip (e.g., each sensor unit may include optical shield 148 that focuses light to/from the discrete portion on the test strip). The discrete portion may be aligned (using techniques described herein) with a specific sensor unit 142. Thus, each sensor unit 142 may only illuminate and receive illumination from the discrete portion that is aligned with the sensor unit and illumination from portions of the test strip other than the discrete portion (e.g., portions not aligned with the sensor unit) is inhibited from being received in the sensor unit.

Having each sensor unit 142 only detect illumination from the discrete portion aligned with the sensor unit allows each sensor unit to discretely or independently detect different (discrete) portions of the test strip. Thus, each sensor 146 (or sensor unit 142) is capable of independently assessing an illumination signal from a discrete (different) portion of the test strip when the test strip is placed in wireless optical device 102.

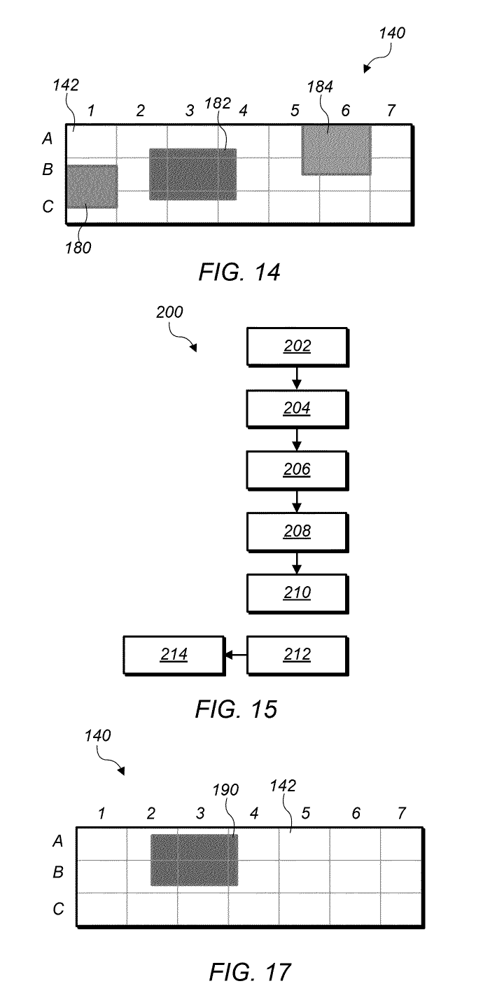

In certain embodiments, sensor array 140 on sensor board 124 includes multiple sensor units 142 arranged in an array or matrix. FIGS. 5 and 6 depict sensor array 140 with two sensor units 142. FIG. 14 depicts a block diagram representation of an embodiment of sensor array 140 with 21 sensor units 142. In the embodiment depicted in FIG. 14, sensor array 140 includes 7 columns (columns 1-7) and 3 rows (rows A-C) of sensor units 142. The sensor unit in the upper left corner of sensor array may be designated as sensor unit 142(1A) while the sensor unit in the lower right corner may be designated as sensor unit 142(7C). Each sensor unit 142 in sensor array 140, as described above, includes an individually addressable sensor and its associated illumination elements that can be discretely directed at a discrete portion of a test strip.

In certain embodiments, sensor units 142 are sized such that multiple sensor units can be positioned above a test strip and individually report signal intensity from different (discrete) portions of the test strip. Using multiple sensor units 142 in sensor array 140, wireless optical device 102 may accommodate a wide variation in placement of test strip 160 and reactive region 172 within the device. For example, different test strips for different applications may have reactive regions that are in different locations along the test strip. Individually addressable sensors in sensor units 142, as shown in FIG. 14, may provide the capability to adjust for differences in test strip size, pad placement (e.g., reactive region placement), and colorimetric signal response for different test strips for different applications. Thus, wireless optical device 102 may be used to universally accept and assess multiple different test strip technologies without the need for an additional optical device and/or modification of the wireless optical device.

In some embodiments, sensors in sensor units 142 are used in combination with one another to provide a substantially complete three-dimensional image of the sample region (e.g., reactive region). For example, quantitative measurements of color signal from each of the sensors may be combined (e.g., interlaced) to provide length, width, and overall signal intensity of the reactive region on the sample. Thus, data from sensor array 140 may be used to provide fully quantitative results from each assessed reactive region.

In some embodiments, one or more individual sensor units 142 within sensor array 140 are turned on for a selected (specific) test being performed on a test strip. Thus, only selected, discrete portions of the test strip may be assessed for the selected test using individual sensor units 142 selected for the test. In some embodiments, information about the selected test is provided as information stored on test strip holder 104. For example, test strip holder 104 may include identifying information about the type or types of test strips supported by the test strip holder. Information stored on test strip holder 104 may be communicated to sensor board 124 via electrical contacts 168. In some embodiments, information about the selected test is provided by a user. For example, the user may provide or select the selected test using an application located in software package 112 on control device 106, shown in FIG. 1.

In some embodiments, program instructions stored in software package 112 on control device 106 include program instructions that run an algorithm (e.g., a method or process) that assesses which sensor units 142 are positioned above the reactive region of the test strip. FIG. 15 depicts a flowchart of an embodiment of process 200 for assessing which sensor units are positioned above the reactive region of the test strip. Process 200 may be accomplished using wireless optical device 102 in combination with program instructions in software package 112 on control device 106, shown in FIG. 1. As shown in FIG. 15, in 202, test strip 160 may be illuminated in wireless optical device 102 using sensor array 140 and illumination elements 144 (after inserting the test strip into the wireless optical device). In 204, illumination from the test strip may be received in sensors 146 in sensor array 140 in wireless optical device 102.

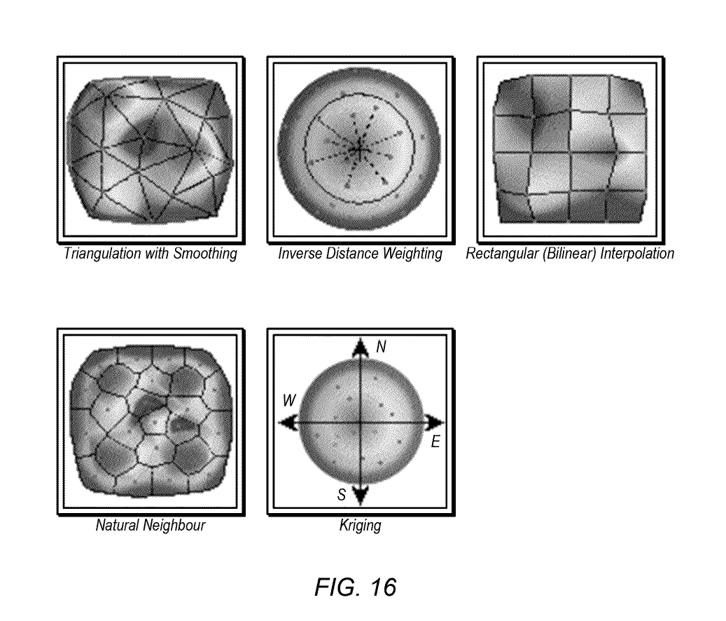

In 206, a signal intensity may be independently (individually) assessed for each sensor 146 receiving illumination from test strip 160. The independent signal intensities (e.g., the data) may be collected by the program instructions running the algorithm on control device 106. In 208, control device 106 may interpolate the independently assessed signal intensities between sensors 146 that received illumination. FIG. 16 depicts examples of different interpolation methods that may be used to interpolate the independently assessed signal intensities in 208. As shown in FIG. 16, possible different interpolation methods include, but are not limited to, triangulation with smoothing, inverse distance weighting, rectangular (bilinear) interpolation, simple or advanced natural neighbour, and kriging.

Interpolation between the independently assess signal intensities for the discrete sensors may be used to provide a 3D color intensity map that represents a signal generated by the test strip between sensors. As an example of interpolation, sensor array 140, as shown in FIG. 14, may be used. Sensor array 140 includes 7 columns and 3 rows of sensor units 142. Three test regions are shown in FIG. 14, first test region 180, second test region 182, and third test region 184.

First test region 180 may be a green test region. As shown in FIG. 14, first test region 180 straddles sensor unit 142(1B) and sensor unit 142(1C). These sensor units would show an increase in the green channel intensity. The total intensity value of first test region 180 may be calculated by averaging sensor unit 142(1B) and sensor unit 142(1C) signal intensities and then multiplying by the number of sensor units (2 sensor units). Since the surrounding sensor units 142(1A), 142(2A), 142(2B), 142(2C) do not have any green channel intensity, they are not included in any results calculation. Additionally, since sensor unit 142(1B) and sensor unit 142(1C) have green channel intensities that may be close to one another, first test region 180 may be considered to be shared among the two sensor units and not single sensor unit, alone, may provide an accurate intensity value report.

Second test region 182 may be a red test region. As shown in FIG. 14, second test region 182 straddles a total of nine sensor units—sensor unit 142(2A), sensor unit 142(3A), sensor unit 142(4A), sensor unit 142(2B), sensor unit 142(3B), sensor unit 142(4B), sensor unit 142(2C), sensor unit 142(3C), and sensor unit 142(4C). These sensor units would show an increase in the red channel intensity. The total intensity value for second test region 182 may be calculated using an intelligent centering algorithm, which looks for the sensor unit with a selected intensity value that is surrounded by selected values. For example, the algorithm may look for the sensor unit with the highest intensity value that is surrounded by lower values. Such an algorithm may indicate that the key sensor unit to observe is sensor unit 142(3B) as it accurately represents the color response of second test region 182 since sensor unit 142(3B) is fully exposed by the second test region. The surrounding sensor unit values may help the algorithm interpolate the values between sensor units and thus may digitally center second test region 182 among the sensor units.

Third test region 184 may be a blue test region. As shown in FIG. 14, third test region 184 straddles a total of four sensor units—sensor unit 142(5A), sensor unit 142(6A), sensor unit 142(5B), and sensor unit 142(6B). The peak blue intensity may be found in sensor unit 142(6A). Since sensor unit 142(7A) and sensor unit 142(7B) have no blue intensity, they may not be included in the calculation. Since sensor unit 142(5A) and sensor unit 142(5B) intensity values are lower than sensor unit 142(6A), it may be determined that third test region 184 is fully exposed to sensor unit 142(6A). Thus, sensor unit 142(6A) intensities may accurately represent intensity for third test region 184.

After interpolation, as shown in FIG. 15, process 200 may include, in 210, selecting a sensor 146 with a selected assessed signal intensity in comparison to assessed signal intensities to its neighboring sensors (e.g., sensors in neighboring sensor units in sensor array 140, shown in FIG. 14). The selected assessed signal intensity may be an assessed signal intensity selected, or a range of assessed signal intensities, based on an area of interest in a range of signal intensities for a certain test strip (e.g., a desired intensity or range of intensities based on the test strip properties). In certain embodiments, the selected assessed signal intensity is the highest assessed signal intensity in comparison to assessed signal intensities to the neighboring sensors. In some embodiments, the selected assessed signal intensity is the lowest assessed signal intensity in comparison to assessed signal intensities to the neighboring sensors. The selected assessed signal intensity may also be a midrange value (e.g., an assessed signal intensity value between the highest and lowest assessed signal intensities).

In 212, a set of sensors in proper position above the reactive region of the test strip may be determined based on the interpolation in 208 and the sensor selected in 210. In 214, the set of sensors determined to be in the proper position may be used to quantitatively assess color signals (e.g., RGB number color intensities) of the signal intensities for the reactive region of the test strip.

In some embodiments, a sample (e.g., test strip) with a known illumination pattern for a specific type of assay may be illuminated. Program instructions stored in software package 112 on control device 106 may then include program instructions that run an algorithm (e.g., a method or process) that provides a learning mode to obtain an appropriate optical response for wireless optical sensor 102. FIG. 17 depicts a block diagram representation of an embodiment of sensor array 140 with known illumination pattern 190 illuminated on the sensor array. Pattern 190 may be a known illumination pattern on a test strip for a specific type of assay.

In certain embodiments, process 200, shown in 15, is performed on the test strip with known illumination pattern 190. In the learning mode, the signal intensities for the determined set of sensor in the proper position (found in 212) are assessed. Because the color intensity of known illumination pattern 190 is known, the algorithm for the learning mode may obtain the appropriate signal intensity by including neighboring sensor unit values in an additive fashion. For example, if the test strip has a color intensity range of 0-255 and known illumination pattern 190 is supposed to provide a reading of 120, then during the learning mode algorithm, neighboring sensor units showing color intensity for the known illumination pattern (e.g., sensor units 142(2A), 142(2B), 142(3A), 142(3B), 142(4A), and 142(4B), as shown in FIG. 17) may have their signal intensities added to provide the proper intensity reading (e.g., the added intensities for the six sensor units showing illumination would be 120). Thus, these six discrete sensor units (sensor units 142(2A), 142(2B), 142(3A), 142(3B), 142(4A), and 142(4B)) may now be used for assessing test strips with the specific type of assay using a template generated for the optical analysis of these test strips.

In certain embodiments, one or more process steps described herein may be performed by one or more processors (e.g., a computer processor) executing instructions stored on a non-transitory computer-readable medium. For example, process 200, shown in FIG. 15, may have one or more steps performed by one or more processors executing instructions stored as program instructions in a computer readable storage medium (e.g., a non-transitory computer readable storage medium).

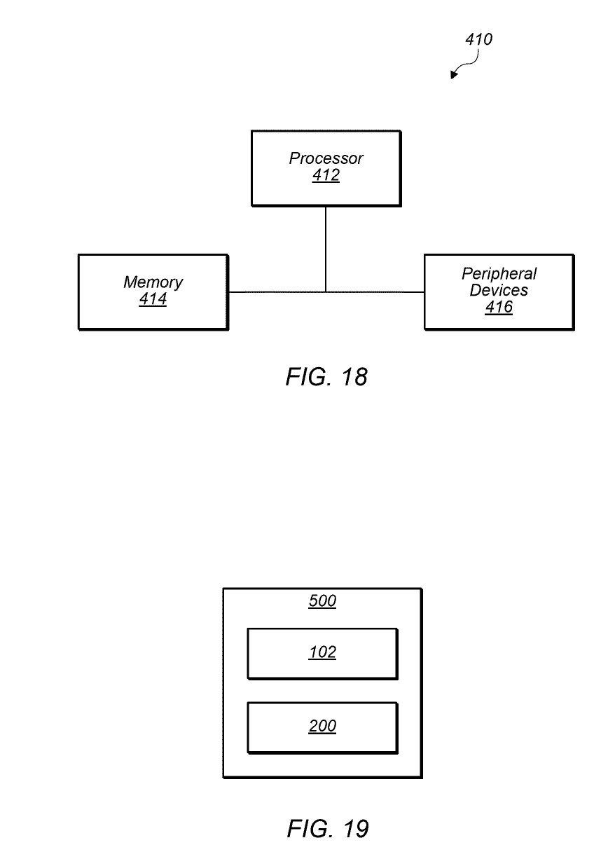

FIG. 18 depicts a block diagram of one embodiment of exemplary computer system 410. Exemplary computer system 410 may be used to implement one or more embodiments described herein. In some embodiments, computer system 410 is operable by a user to implement one or more embodiments described herein such as process 200, shown in FIG. 15. In the embodiment of FIG. 18, computer system 410 includes processor 412, memory 414, and various peripheral devices 416. Processor 412 is coupled to memory 414 and peripheral devices 416. Processor 412 is configured to execute instructions, including the instructions for process 200, which may be in software. In various embodiments, processor 412 may implement any desired instruction set (e.g. Intel Architecture-32 (IA-32, also known as x86), IA-32 with 64 bit extensions, x86-64, PowerPC, Sparc, MIPS, ARM, IA-64, etc.). In some embodiments, computer system 410 may include more than one processor. Moreover, processor 412 may include one or more processors or one or more processor cores.

Processor 412 may be coupled to memory 414 and peripheral devices 416 in any desired fashion. For example, in some embodiments, processor 412 may be coupled to memory 414 and/or peripheral devices 416 via various interconnect. Alternatively or in addition, one or more bridge chips may be used to coupled processor 412, memory 414, and peripheral devices 416.

Memory 414 may comprise any type of memory system. For example, memory 414 may comprise DRAM, and more particularly double data rate (DDR) SDRAM, RDRAM, etc. A memory controller may be included to interface to memory 414, and/or processor 412 may include a memory controller. Memory 414 may store the instructions to be executed by processor 412 during use, data to be operated upon by the processor during use, etc.

Peripheral devices 416 may represent any sort of hardware devices that may be included in computer system 410 or coupled thereto (e.g., storage devices, optionally including computer accessible storage medium 500, shown in FIG. 19, other input/output (I/O) devices such as video hardware, audio hardware, user interface devices, networking hardware, etc.).

Turning now to FIG. 19, a block diagram of one embodiment of computer accessible storage medium 500 including one or more data structures representative of wireless optical device 102 (depicted in FIG. 1) and one or more code sequences representative of process 200 (shown in FIG. 15). Each code sequence may include one or more instructions, which when executed by a processor in a computer, implement the operations described for the corresponding code sequence. Generally speaking, a computer accessible storage medium may include any storage media accessible by a computer during use to provide instructions and/or data to the computer. For example, a computer accessible storage medium may include non-transitory storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, or Flash memory. The storage media may be physically included within the computer to which the storage media provides instructions/data. Alternatively, the storage media may be connected to the computer. For example, the storage media may be connected to the computer over a network or wireless link, such as network attached storage. The storage media may be connected through a peripheral interface such as the Universal Serial Bus (USB). Generally, computer accessible storage medium 500 may store data in a non-transitory manner, where non-transitory in this context may refer to not transmitting the instructions/data on a signal. For example, non-transitory storage may be volatile (and may lose the stored instructions/data in response to a power down) or non-volatile.

Further modifications and alternative embodiments of various aspects of the embodiments described in this disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as the presently preferred embodiments. Elements and materials may be substituted for those illustrated and described herein, parts and processes may be reversed, and certain features of the embodiments may be utilized independently, all as would be apparent to one skilled in the art after having the benefit of this description. Changes may be made in the elements described herein without departing from the spirit and scope of the following claims.

What is claimed is:

1. A portable optical analysis system, comprising:
a body comprising a port configured to receive at least one test strip;
a sensor array positioned within the body, wherein the sensor array is positioned to align with at least part of the at least one test strip when the at least one test strip is received in the port, and wherein the sensor array comprises:
a plurality of individually addressable sensors; and
at least one illumination element associated with each individually addressable sensor, wherein the at least one illumination element illuminates a discrete portion of the at least part of the at least one test strip, the discrete portion being aligned with the individually addressable sensor associated with the at least one illumination element;
wherein the individually addressable sensors are configured to independently assess reflected illumination signals from the discrete portions of the at least part of the at least one test strip aligned with the individually addressable sensors.

2. The system of claim 1, wherein each individually addressable sensor is configured to independently assess reflected illumination signals from the discrete portion aligned with the individually addressable sensor.

3. The system of claim 1, wherein the sensor array is configured to illuminate one or more selected discrete portions of the at least one test strip, the selected discrete portions being determined based on a selected test being performed by the optical analysis system.

4. The system of claim 1, wherein an individually addressable sensor is configured to align with its discrete portion on the at least one test strip when the at least one test strip is received in the port.

5. The system of claim 1, further comprising a test strip holder configured to hold the at least one test strip, wherein the test strip holder is configured to be received in the port in the body while holding the at least one test strip.

6. The system of claim 1, further comprising an optical shield located in the body and positioned over at least one individually addressable sensor and its associated at least one illumination element, wherein the optical shield directs illumination from the associated at least one illumination element towards the discrete portion aligned with the at least one individually addressable sensor.

7. The system of claim 6, wherein the optical shield directs reflected illumination signals from the discrete portion of the test strip into the at least one individually addressable sensor aligned with the discrete portion.

8. The system of claim 6, wherein the optical shield inhibits illumination from portions of the test strip not aligned with the at least one individually addressable sensor from being received in the at least one individually addressable sensor aligned with the discrete portion.

9. The system of claim 6, wherein the optical shield comprises at least one optical filter for optical wavelength and/or optical intensity.

10. The system of claim 1, further comprising a switch located in the body, wherein the switch is configured to be activated when the at least one test strip is received in the port, and wherein the sensor array is configured to be activated when the switch is activated.

11. The system of claim 1, wherein the sensor array is configured to wirelessly communicate with a computer processor, the computer processor being configured to control operation of the sensor array.

12. The system of claim 1, wherein the body comprising the port comprises a handheld body.

13. The system of claim 1, wherein the illumination signals comprise color signals.

14. The system of claim 13, wherein the individually addressable sensors are configured to quantitatively assess an RGB number intensity of the color signals.

15. A method, comprising:
illuminating a test strip located in an optical analyzer body with a plurality of illumination elements located in the optical analyzer body;
receiving illumination from the test strip in a plurality of sensors located in the optical analyzer body, wherein each sensor is associated with at least one illumination element;
independently assessing, using a computer processor, a signal intensity of the illumination on each of the sensors receiving illumination from the test strip;
interpolating, using the computer processor, the assessed signal intensities between the sensors receiving illumination from the test strip;
selecting, using the computer processor, a sensor with a selected assessed signal intensity in comparison to the assessed signal intensities of its neighboring sensors; and
determining, using the computer processor, a set of sensors in proper position above a test region on the test strip based on the interpolation of the assessed signal intensities and the selected sensor with the selected assessed signal intensity.

16. The method of claim 15, wherein the assessed signal intensity of the illumination comprises a color signal intensity.

17. The method of claim 15, wherein the selected assessed signal intensity comprises an assessed signal intensity in a range of assessed signal intensities selected in comparison to the assessed signal intensities of its neighboring sensors.

18. The method of claim 15, wherein the selected assessed signal intensity comprises a highest assessed signal intensity selected in comparison to the assessed signal intensities of its neighboring sensors.

19. The method of claim 15, wherein the selected assessed signal intensity comprises a lowest assessed signal intensity selected in comparison to the assessed signal intensities of its neighboring sensors.

20. The method of claim 15, further comprising quantitatively assessing, using the computer processor, RGB number color intensities of the signal intensities for the determined set of sensors in the proper position.

21. The method of claim 15, further comprising receiving the test strip in the port of the optical analyzer body.

22. The method of claim 15, wherein the sensors are individually addressable by the computer processor such that the computer processor independently assesses the signal intensity of the illumination on each of the sensors receiving illumination from the test strip.

23. The method of claim 15, wherein the computer processor independently assesses a separate signal intensity for each sensor receiving illumination from the test strip.

24. The method of claim 15, wherein the optical analyzer body is wirelessly separated from the computer processor.

25. The method of claim 15, wherein the plurality of sensors and the plurality of illumination elements wirelessly communicate with the computer processor.

26. The method of claim 15, wherein the computer processor is located on a mobile device.

27. The method of claim 15, wherein the test strip comprises a test strip with a test region having a known illumination pattern for a specific type of assay, and wherein the method further comprises:
determining the set of sensors in proper position above the test region in the known illumination pattern; and
generating a template for optical analysis of test strips with the specific type of assay, wherein the generated template includes using the determined set of sensors to assess illumination from such test strips.

28. A non-transient computer-readable medium including instructions that, when executed by one or more processors, causes the one or more processors to perform a method, comprising:
illuminating a test strip located in an optical analyzer body with a plurality of illumination elements located in the optical analyzer body;
receiving illumination from the test strip in a plurality of sensors located in the optical analyzer body, wherein each sensor is associated with at least one illumination element;
independently assessing a signal intensity of the illumination on each of the sensors receiving illumination from the test strip;
interpolating the assessed signal intensities between the sensors receiving illumination from the test strip;
selecting a sensor with a selected assessed signal intensity in comparison to the assessed signal intensities of its neighboring sensors; and
determining a set of sensors in proper position above a test region on the test strip based on the interpolation of the assessed signal intensities and the selected sensor with the selected assessed signal intensity.
